(19) United States
(12) Patent Application Publication
(10) Pub. No.: US 2008/0320074 A1
(43) Pub. Date: Dec. 25, 2008

(54) METHOD AND APPARATUS FOR EFFICIENT PEER NETWORK SET-TOP BOX WEB-CASTING

(76) Inventor: Owen Guy Jones, North Port, FL (US)

Correspondence Address: MCHALE & SLAVIN, P.A., 2855 PGA BLVD, PALM BEACH GARDENS, FL, 33410, US

(21) Appl. No.: 11/753,203

(22) Filed: May 24, 2007

Related U.S. Application Data
(60) Provisional application No. 60/803,094, filed on May 24, 2006.

(51) Int. Cl. G06F 15/16

(52) U.S. Cl. 709/203

(57) ABSTRACT

A device and method for efficient set-top box web-casting utilizing a peer network protocol. The device is connected to data servers on the network and acts as a stand alone internet node. The device plays, receives, and distributes content. The device can insert one medium into another; it adheres to media availability restrictions and has a friendly graphical interface.

### PRIORITY CLAIM

This Application claims the priority date of Provisional patent application 60/803,094 filed May 24, 2006 the contents of which are incorporated herein by reference.

### FIELD OF THE INVENTION

The present invention relates to an always on apparatus which permits the reception and distribution of multimedia (audio/video/etc.) over the Internet utilizing a peer network protocol, for displaying on a monitoring device (i.e. a television) with the ease of use of a set-top box GUI (graphical user interface) making it extremely simple for the consumer to receive and relatively inexpensive to distribute.

### BACKGROUND OF THE INVENTION

In the television and radio broadcast industry, the cost of distribution of audio and video to listeners and viewers is enormously expensive for content producers and therefore excludes low budget productions from reaching a multitude of people. Your average mom and pop content producers are unable to get one of their productions into the home of your average television viewer and onto their television set.

The Internet has made it easy for print journalists to get their pieces out to a large audience and has effectively changed the face of journalism. This has opened the door for the non-professional journalist to be heard and has even created a revenue stream for some of these non-pro journalists. Audio and video producers however have not been afforded the same exposure that print journalism has because of the enormous expense of distribution and the complexity of both the distribution process and reception by the viewer.

Audio and video are not nearly as comfortable or enjoyable when watched on a computer rather than a television. It is also certainly a lot more complex to acquire, install, configure, update, repair, and troubleshoot audio and video players for Internet multimedia. It is these complexities that prevent a person that is not computer savvy, such as my mother-in-law, from watching Internet audio and video content. The main reason is because all Internet multimedia are not the same. There are differences in operating systems, browsers, drivers, codec, playback software, and even hardware requirements.

Peer networks protocols have been around for quite some time but have never been incorporated into a set-top box with a dedicated mother-in-law proof GUI to aid producers in cost effectively distributing content to viewers. It would be great if when you turned on your television at 8 pm on Tuesday night your favorite comedy distributed by NBC is there waiting for you to watch, or that less known show from unpopular producers only you and two other people watch, is there ready for you to sit down comfortably in your living room and enjoy.

Internet content producers with small budgets currently seek out sponsors for their programs and then refer to them in their shows as to aid in the cost of production. This process is quite tedious, time consuming and inefficient. So with the high cost of Internet bandwidth, producers make very little and usually only break even. Their viewers are usually Internet and computer savvy and for that reason not a really large audience. This is a limiting factor on their potential number of viewers and their possible income.

The present apparatus is always on and connected to the Internet when network connection and electrical power permits. Others nodes of the same invention, will connect to each other to shared multimedia in a peer network format. Whether connected to the necessary servers or not, the present invention may automatically insert audio or video into the currently playing program. The inserted content could be related to the category of the program, interests of the user, or neither. Currently no device like this exists to permit this facility.

### DESCRIPTION OF THE PRIOR ART

U.S. Pat. No. 5,515,098 to Carles is directed to a device and method of distributing commercial messages to an individually addressable subscriber terminal. A server, located on the network, selectively tags commercial messages with routing information and converter addresses, and transmits the messages on the network to be received and displayed by the addressed converters. U.S. Pat. No. 6,600,496 to Wagner et al is directed to a graphical user interface for a set top box which includes a web browser. The graphical user interface generates menu screens that are superimposed over conventional television video images, so that the user can view the browser graphics while viewing the television images in the background. U.S. Pat. No. 5,481,542 relates to a control system for establishing an information session connection between a customer's set top terminal and the service provider or other user and then managing the bidirectional network communications necessary to provide the interactive information services to the customer. U.S. Pat. No. 5,990,927 to Hendricks et al is directed to a set top box capable of digital decompression, menu generation, interactivity and other functional capabilities for use in a television program delivery system.

### SUMMARY OF THE INVENTION

The present invention utilizes a user friendly GUI, microprocessors, and the inexpensive distribution system found in peer networks akin to a BitTorrent protocol type network, to facilitate the following scenario.

A content producer logs in and uploads audio or video content to the server on which he or she is registered as a producer of content. This media, called the featured media, is put into the category in which it is related and producer decides whether he or she wants the content to be mixed with other media, unmixed, or owned. If the featured media is to accept insertions of other mediums, it must be marked by its producer at specific points at which other mediums are to be inserted. Subsequent media producers, of media to be inserted into the featured media at time of playback, upload their media to a specific server and select the categories to which it belongs. If the featured media provider's and the subsequent media provider's content are in analogous categories, the invention, with or without the instruction of a coaching server, will insert the subsequent media into the featured media for seamless playback at the points specified by the featured media producer. All these media types are stored on the invention's storage system. This is all done without the need for the content producers to have any relation one to the other.

Each device of the present invention connected to the Internet is a node in a peer network. These nodes receive multimedia contents from a server and share these contents between connected nodes as needed as to save bandwidth of the original content server. Content of any category can either be solely selected for viewing or received on a subscription basis. The GUI facilitates the sole selection or subscription process. The data servers, to which all nodes have access, provide all the necessary information for media acquisition, insertion, restrictions, etc.

Programs received on the present invention have restrictions which govern when they will become available to the user. Although a program may be completely received, the producer or network administrator may set specific date and time restrictions. Each program can only be played within the set timeframe and is subject to deletion after expiration. During that time, the user may have control of the programs including but not limited to, starting, pausing, forwarding, rewinding, and stopping. This is all done via a remote controller or by the front panel controls of the present invention.

To summarize, the invention has all the following characteristics: always on, standalone Internet node, incorporates microprocessors, utilizes a storage medium, peer networked, connects to data servers, plays multimedia, receives and distributes content, insert one media into another, adheres to media availability restrictions, has a user friendly graphical interface, and has all the typical functions of a typical media player.

There is currently no easy to use device now available which permits this facility. There is no process now available for producers of content to use peer networks to easily deliver content directly to the television in the home of viewers and intermix these different contents with other media producers. So this present invention facilitates a solution to the above mentioned problems efficiently and effectively. Accordingly, it is a primary objective of the instant invention to facilitate in the cost effective delivery of multimedia into the living room over the Internet, utilizing network technologies including but not limited to current standard Internet network protocols.

It is a further objective of the instant invention is to provide an experience that is both easy and comfortable for the user in viewing content distributed over the Internet.

It is yet another objective of the instant invention to facilitate in on-the-fly insertion of subsequent media into featured multimedia content without the direct intervention of the program producer or subsequent media provider. The invention can change the sequence or selection of inserted media corresponding to server, network controller, or user intervention, every time it is played. The invention could also be used to facilitate in the ownership of the same media.

It is a still further objective of the invention to facilitate the automatic management of viewable timeframes for media it acquires. This restriction is set by the media producer or the network facilitator.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic view of the peer network

FIG. 2 is a perspective view of the front of the control box of the instant invention.

FIG. 3 is a perspective view of the rear of the control box of the instant invention.

FIG. 4 is a perspective view of the hand held wireless remote control for the control box of the invention.

FIG. 5 is an example of the graphic user interface for searching the featured programs.

FIG. 6 is a schematic representation of how the featured programming and subsequent programming are introduced into the data server and subsequently into the peer network.

FIG. 7 is a representation of the transmission of multiple featured presentations separated by break markers which are pictorially represented by squiggly lines.

FIG. 8 is a representation of subsequent insertable media.

FIG. 9 is a representation of a seamless data playback including featured media playback and subsequent media that has been added.

FIG. 10 is a flow chart illustrating the various steps involved with the process of using the instant invention.

### DETAILED DESCRIPTION OF THE INVENTION

FIG. 1 is a representation of the peer network system showing the location of main servers 1 within the network as well the devices 2 of the present invention which function as nodes within the peer network. Each device 2 incorporates microprocessors, utilizes a storage medium, provides communications hardware and in addition contains software to support the friendly graphic user interface.

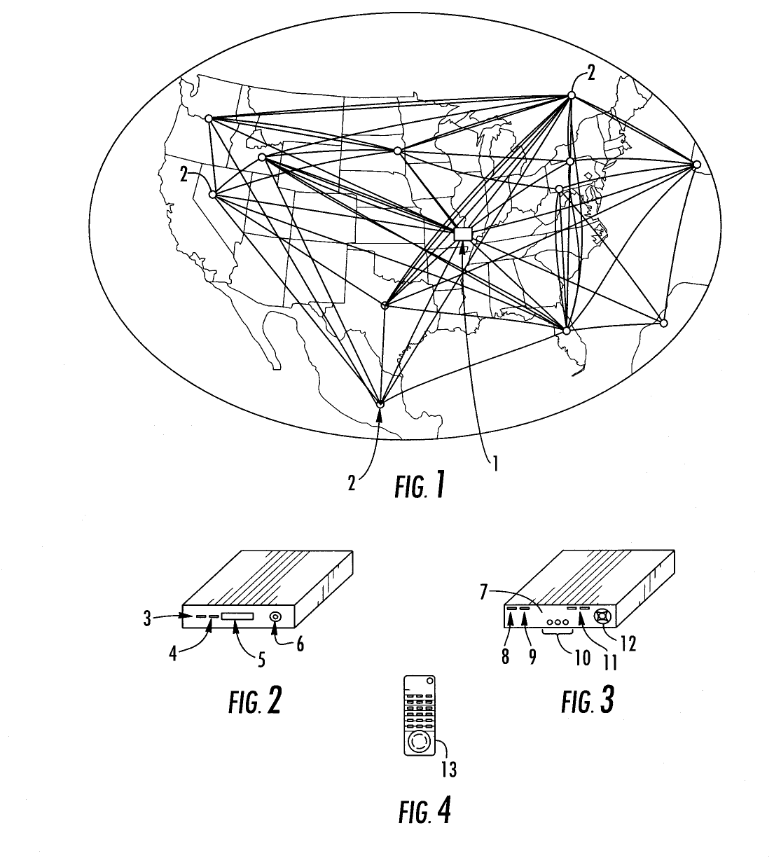

As shown in FIG. 2, the front panel 3 of the device 2 includes status lights 4, various operational displays 5, as well as manual controls 6. The rear panel 7, of the device 2, as shown in FIG. 3, includes a wan port 8, a network connection 9, output connections 10 to the television, expansion ports 11 and a fan 12. FIG. 4 is representation of a wireless remote control 13 for the device 2.

FIG. 5 is a representation of the graphic user interface contemplated for this invention. The screen shown in FIG. 5 is by way of example only, as the content and format can be tailored to the individual's personal taste. In the example shown in FIG. 5 the content includes a video/audio media preview, a written description of the material and a program listing.

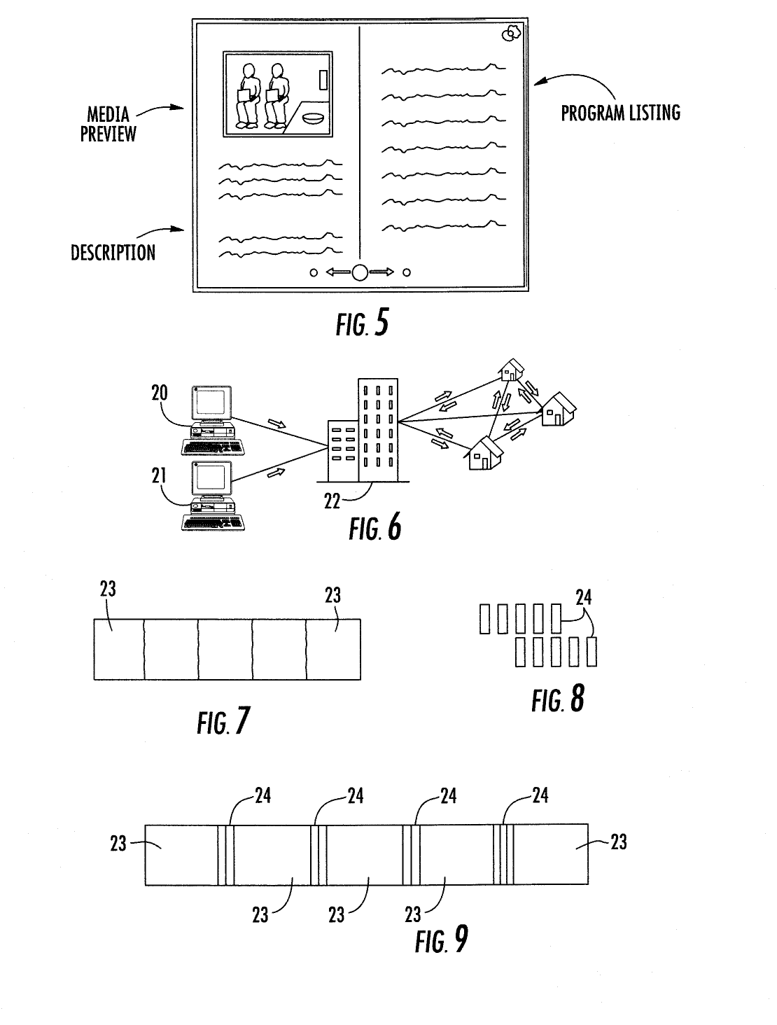

FIG. 6 is a pictorial representation of how the data is transmitted by the featured program producer 20 and subsequent program producer 21 to the data server facility 22. The data is then subsequently available on the peer network with the devices 2 acting as nodes within the network.

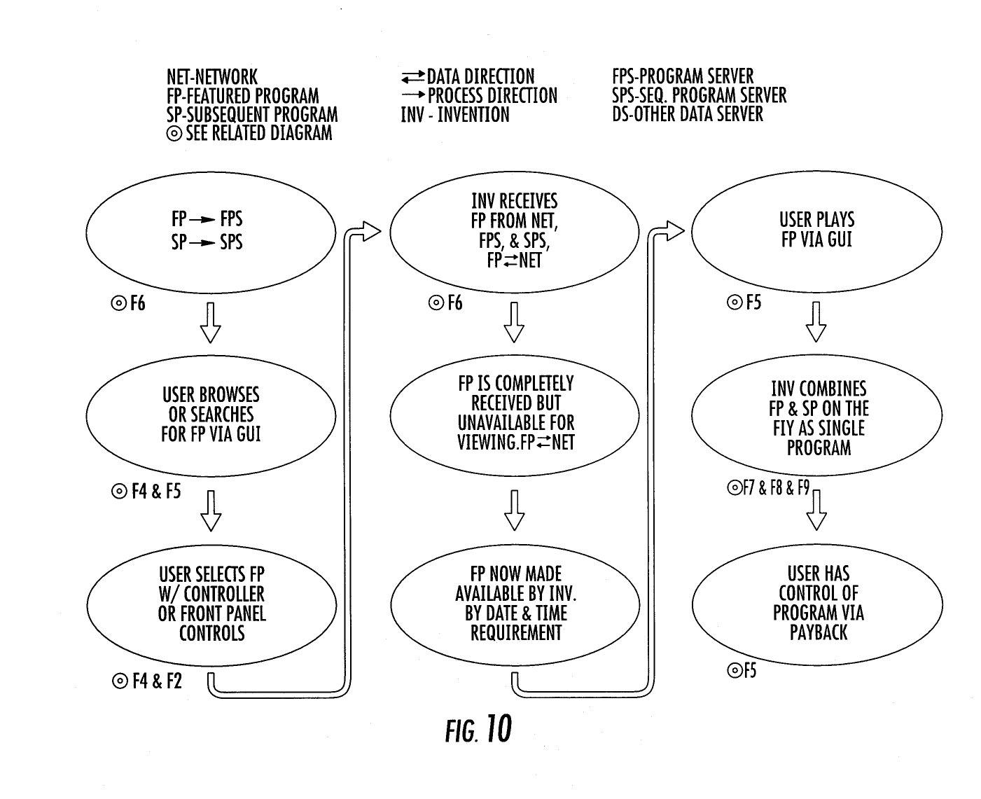

FIG. 7 is a pictorial representation of the data stream containing the feature presentation that was selected by the user for viewing or subscription with break markers between the presentations depicted as squiggly lines. FIG. 8 is a showing of data each representing subsequent insertable media. FIG. 9 is a representation of a seamless data playback. The large blocks 23 represent the featured media segment and each small block 24 represents subsequent media inserted on the fly.

FIG. 10 is a flow chart describing the process of using the device of the instant invention in a peer network environment. As shown, the featured programming is uploaded to the featured program server and the subsequent programming is likewise uploaded to the subsequent program server. The user browses or searches for featured programming utilizing device 2 and the graphic user interface appearing on the television or monitor. The user then selects the featured programming with the wireless remote 13 or front panel controls 6. The device 2 then receives the featured programming and subsequent programming from the network. At this point the featured and subsequent programming is completely received but may not be available for viewing until permission is received from the network. Once the date and time requirements have been satisfied the featured programming will be made available for viewing. The user then uses device 2 and the graphic user interface to play the featured programming. Device 2 can then combine the featured programming and subsequent programming on the fly to be viewed as a single program. At this point the user has control of the program playback.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An apparatus for selectively distributing multimedia over a communications network comprising:
a source of featured programming material,
a first server containing said featured programming material,
a source of subsequent programming material,
a second server containing said subsequent programming material,
a data server connected to said first and second server,
an internet network utilizing a peer network protocol, said network connected to said server,
a plurality of devices connected to said network and a monitoring device,
wherein each of said devices acts as a node within the network,
said device including micro processors, recording medium and software to provide a user friendly graphic interface.

2. The apparatus of claim 1 wherein the featured programming material and subsequent programming material can be combined by the device without the intervention of the featured programming source or subsequent programming source.

3. The apparatus of claim 1 wherein a control is placed on the device to automatically manage the viewable time frames of the featured and subsequent programming material.

4. The apparatus of claim 2 wherein the device enables the user to select the featured and subsequent programming material and the manner in which they can be combined.

5. A method for efficient peer network set-top box web-casting comprising the steps of:
creating featured programming material and loading the material on to a featured program material server,
creating subsequent programming material and loading the material on to a subsequent program server,
uploading the featured and subsequent programming on to a data server,
browsing the data server utilizing a network device, having a graphic user interface, for featured and subsequent programming material,
selecting featured programming material and subsequent programming material using the network device,
receiving the selected programming material and subsequent programming material in the network device.

6. The method of claim 5 further including the steps of:
enabling the user to view the featured and subsequent programming material once a pre-established date and time requirement have been satisfied.

7. The method of claim 6 further including the step of:
playing the featured and subsequent programming material using a graphic user interface.

8. The method of claim 5 further including the step of:
using the network device to combine the featured and subsequent programming material on the fly and view as a single program.
